(19) United States
(12) Patent Application Publication
(10) Pub. No.: US 2003/0014199 A1
(43) Pub. Date: Jan. 16, 2003

(54) System and methods for detecting fault in structure

(76) Inventor: Patrick Toomey, Lilburn, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/904,348

(22) Filed: Jul. 12, 2001

(51) Int. Cl. G05B 15/02; G05B 19/18; G01L 7/00; G01N 11/00; G01F 17/00; G06F 19/00; G01F 23/00

(52) U.S. Cl. 702/56; 700/10

(57) ABSTRACT

Disclosed methods can be used to detect the existence and location of a fault in a structure such as a building or house. Such fault can be due to damage or deterioration to structure elements, or can be due to improper use, design, or assembly, for example. The methods use optical sensing to detect vibration from a structure. The sensed vibration is highly dependent upon the condition of the structure elements, so that the existence and location of a fault in the structure can be readily detected.

### BACKGROUND OF THE INVENTION

1. Field of the Invention

The invented system and methods pertain to the detection of a fault in a structure such as a building or house. Such fault can be the result of the environment, such as deterioration of structural elements through exposure to weather. Alternatively, such fault can be due to error in design, material-selection, or construction of the structure. Through use of the disclosed methods, one can detect a fault to affect repair and remediation of the structure.

2. Description of the Related Art

Previous inspection techniques applied to structures such as buildings or houses rely heavily on visual examination to uncover problems that may indicate a fault in the structure. However, many parts of a structure, such as those structural elements hidden by walls, cannot be observed visually without invasive approaches that damage a portion of the structure to allow observation of normally hidden areas. For example, to observe the condition of frames or supports within a wall space, it may be necessary to cut holes in the walls covering such frames or supports. However, damage and repair of a portion of a structure for inspection of hidden structural elements involves a considerable amount of time and expense. The need for non-invasive approaches to inspect a structure for the existence of faults is thus manifest.

Among non-invasive techniques for examining a structure is infrared scanning. Although highly effective for the detection of water problems, infrared scanning is not especially effective to detect the existence of faults directly, although it may do so indirectly by indicating an area of the structure that is the source of a water problem. It would be desirable to provide a method that can detect the existence of a fault directly through non-invasive means.

A technology related to this invention, although believed never to have been used to detect faults in a structure, is the laser vibrometer. The laser vibrometer has been used in the analysis of objects with moving parts such as an automobile or aircraft engine, but has never until now been applied to the detection of vibrations in a structure such as a building or house. It would be desirable to apply the laser vibrometer to achieve benefits heretofore unknown.

### SUMMARY OF THE INVENTION

A first disclosed method comprises optically sensing vibration from a structure, and determining whether a fault exists in the structure, based on the optically-sensed vibration. The fault can be damage or deterioration to a structure element, or a dislocation of structure elements normally joined, or improper joining of structure elements, for example. Such structure elements can be a foundation, roof, ceiling, floor, wall, beam, column, support, joist, wall, wall panel, wall frame, window, window frame, duct, plumbing, piping, or hanger, for example. The optical sensing can be performed by an optical vibration sensor (OVS) that can be a laser vibrometer, for example. The determination of whether a fault exists in the structure can be performed by a computer and/or a human operator.

The optical sensing can be performed by generating and transmitting a laser beam to the structure, receiving the laser beam from the structure, detecting Doppler shift in the received laser beam relative to the transmitted laser beam, and determining at least one of the peak displacement and velocity of the vibration, based on the detected Doppler shift. The Doppler shift can be used to determine peak displacement and/or velocity of the vibration from a corresponding portion of the structure. Such peak displacement and/or velocity can be referred to as a ‘vibration signal’ or ‘vibration data’. The vibration signal can be used in the method to determine whether a fault exists in the structure in at least one of three ways: the “threshold” method, “comparison” method, and “baseline” method. In the threshold method, vibration data is compared with threshold data, and if it exceeds such data, a fault is determined to exist in the structure. Conversely, if the vibration data does not exceed the threshold data, a fault is determined not to exist in the structure at the portion thereof from which the vibration data was obtained. In the comparison method, vibration data from similar portions of the structure are compared. If vibration data of one portion is significantly greater than those of others, a fault is determined to exist at the portion of the structure to which the vibration data corresponds. If the vibration data are not significantly greater than those of others, a fault is determined not to exist at the portion of the structure to which the vibration data corresponds. In the base line method, vibration data over a scan of the structure is obtained and is stored as base line data. At a later time, the vibration data is again sensed from the structure and is compared with the base line data. If the later-acquired data differs significantly from the base line data, a fault can be determined to have occurred in the structure at the portion thereof corresponding to the significantly different vibration data. Conversely, a fault can be determined not to exist at a portion of the structure if corresponding base line data and vibration data are not significantly different.

The method can further comprise vibrating the structure to produce the structure vibration so that it can be optically sensed. The structure can be vibrated by driving a vehicle over spaced objects to vibrate the structure, vibrating the ground in proximity to the structure with a ground vibrator, and/or vibrating the ground proximate to the structure by generating an explosion. Furthermore, the structure can be vibrated by generating sonic waves using a speaker or noise from a helicopter. Moreover, the structure can be vibrated through direct application of force to the structure, such as by bumping the structure with a vehicle. As another possibility, the structure can be vibrated through wind loading.

A second disclosed method comprises optically sensing vibrations at spaced portions of a structure to produce a first set of vibration data readings, and establishing base line data from the first set of vibration data readings for respective spaced portions of the structure. At a time after completion of performance of the first sensing, the method comprises optically sensing vibrations at the spaced portions of the structure to produce a second set of vibration data readings, and comparing the vibration data readings of the second set with corresponding vibration data readings of the first set constituting the base line data to generate comparison result data. The method comprises determining whether a fault exists in the structure at the time of performance of the second optical sensing, based on the comparison result data.

A disclosed system comprises an optical vibration sensor (OVS) positioned in proximity to the structure. The OVS optically senses vibration from the structure, and generates an OVS signal based thereon. The OVS signal can indicate the magnitude of the sensed vibration that in turn indicates whether a fault exists in the structure. This magnitude can be the displacement and/or velocity of the sensed vibration. The system can comprise a computer coupled to receive the OVS signal. The computer can generate a display based on the OVS signal so that a human user can determine whether a fault exists in the structure. The computer can use a ‘threshold’ method to determine whether a fault exists in the structure. In this method, the computer determines if the OVS signal indicates that a peak displacement and/or velocity of the vibration at a portion of the structure, exceeds threshold amount data stored in the computer. The computer can generate the computer signal to indicate that a fault exists in the structure if the computer determines that the OVS signal indicates that the vibration's peak displacement and/or velocity exceeds threshold amount data stored in the computer. Alternatively, the computer can use the ‘comparison’ method to determine whether a fault exists in the structure. In this method, the computer can store the OVS signal having vibration data for different portions of the structure. The computer can determine whether a fault exists in the structure by comparing vibration data for similar structure elements to determine if there is a difference in the vibration data of similar structure elements. As yet another alternative, the computer can receive the OVS signal from a first performance of optical sensing to establish baseline data including vibration data readings at spaced portions over the structure. The computer can receive after-acquired data including vibration readings from the spaced portions of the structure received in the OVS signal in a subsequent performance of the optical sensing. The computer compares the after-acquired data with corresponding baseline data, and determines that a fault exists in the structure if the difference between the after-acquired data and the baseline data exceeds threshold data stored in the computer. The system can comprise an output device coupled to the computer. The output device can generate a printed document indicating vibration data and any fault data, based on the computer signal. The computer can comprise a drive unit for writing vibration data including fault data indicating whether a fault exists in the structure onto a computer readable-medium, using the computer signal. The computer can also be coupled to supply the computer signal indicating whether a fault exists in the structure to a remote computer via a network. The system can comprise an OVS controller (OVSC) coupled to receive the signal from the OVS. The OVSC can generate a vibration signal indicating vibration displacement and/or velocity of at least one portion of the structure. The OVSC can be coupled to supply the vibration signal indicating the vibration displacement to the computer as the OVS signal. The OVSC can be coupled to the OVS, and can be operable to automatically focus the OVS on the structure. The system can further comprise a tripod coupled to the OVS. The tripod can be used to position and support the OVS in relation to the structure. The system can further comprise a pan/tilt head coupled to the OVS. The pan/tilt head can be used to align the OVS relative to the structure. In addition, the system can comprise a position controller coupled to the pan/tilt head. The position controller can be controlled by the computer and/or human operator to generate a position signal supplied to the pan/tilt head to control alignment of the OVS relative to the structure. The OVS can comprise a laser/sensor head, an optical element such as a filter and/or lens, and/or a scan unit. The scan unit can generate a laser beam with a laser/sensor head to scan over different portions of the structure, and to receive the scanned laser beam from the different portions of the structure to generate the OVS signal to include vibration data from such portions of the structure. The system can further comprise a vibration generator positioned in proximity to the structure. The vibration generator produces vibrations that travel to and vibrate the structure. The vibration generator can comprise a vehicle and spaced objects. The vehicle drives over the spaced objects to vibrate the ground in proximity to the structure, to in turn vibrate the structure. Alternatively, the vibration generator can comprise a ground vibrator that vibrates the ground in proximity to the structure, to in turn vibrate the structure. As yet another alternative, the vibration generator can comprise a speaker generating sonic waves in proximity to the structure. Furthermore, the vibration generator can comprise an explosive detonated in proximity to the structure to produce a shock wave to vibrate the structure. As another alternative, the vibration generator can comprise a helicopter generating noise. The helicopter can be flown in proximity to the structure to vibrate the structure with the noise generated by the helicopter. The vibration generator can alternatively apply direct force to the structure. For example, the vibration generator can be a vehicle driven to bump and vibrate the structure.

Further details of the construction and operation of the invention are hereinafter described and claimed. In the detailed description, reference is made to the accompanying drawings, forming a part of this disclosure, in which like numerals refer to like parts throughout the several views. The drawings are not necessarily to scale, emphasis instead being placed upon illustration of the principles of the invention.

### BRIEF DESCRIPTION OF THE DRAWINGS

FIG. 1 is an exemplary version of a disclosed system for optically sensing a fault in a structure;

FIGS. 2A and 2B are graphs of frequency of a laser beam incident to a portion of a structure, and the Doppler-shifted frequency of the laser beam caused by vibration of the structure, respectively;

FIG. 3 is a block diagram of an exemplary version of an optical vibration sensor (OVS) of the disclosed system;

FIG. 4 is a block diagram of an exemplary version of an OVS controller (OVSC) of the disclosed system;

FIG. 5 is a block diagram of an exemplary version of a computer of the disclosed system;

FIG. 6 is a block diagram of a position controller and positioner used for alignment of the OVS of the disclosed system;

FIG. 7A is an exemplary version of the vibration generator comprising a vehicle and objects over which the vehicle is driven;

FIG. 7B is an exemplary version of the vibration generator using a seismic vibrator;

FIG. 7C is an exemplary version of the vibration generator comprising an explosive device to generate sonic and seismic shock waves to vibrate the structure;

FIG. 7D is an exemplary version of the vibration generator comprising a sonic wave generator for generating sonic waves to vibrate the structure;

FIG. 7E is an exemplary version of the vibration generator comprising a helicopter for generating sonic waves to vibrate the structure;

FIG. 7F is an exemplary version of the vibration generator comprising a motorized vehicle for contacting the structure to generate vibration therein;

FIGS. 8A and 8B are views of a structure from which vibration is optically-sensed to determine base line and later-acquired data, respectively;

FIGS. 9A and 9B are views of base line data and later-acquired data used to determine whether a fault has developed in the structure;

FIG. 10 is a flowchart of a general method of determining whether a fault exists in a structure based on optically-sensed vibration;

FIG. 11A is a flowchart of a method for generating vibrations by driving a vehicle over an object in proximity to the structure;

FIG. 11B is a flowchart of a method for generating vibrations using a seismic vibrator;

FIG. 11C is a flowchart of a method for generating vibrations using an explosive device;

FIG. 11D is a flowchart of a method for generating vibrations to vibrate a structure using a sound generator;

FIG. 11E is a flowchart of a method for generating vibrations to vibrate a structure using a helicopter;

FIG. 11F is a flowchart of a method for generating vibrations to vibrate a structure by applying force to the structure;

FIG. 12 is a flowchart of a method for optically sensing vibrations from a structure;

FIG. 13A is a flowchart of a method for determining whether a fault exists in the structure using the “threshold” method;

FIG. 13B is a flowchart of a method for determining whether a fault exists in the structure using the “comparison” method; and

FIG. 14 is a flowchart of a method for determining whether a fault exists in the structure using the “base line” method.

### DETAILED DESCRIPTION OF THE INVENTION

1. Definitions

As used herein, the following terms have the following definitions:

“Computer” refers to a programmed data processing device capable of generating output data based on input data by executing computer instructions. In the disclosed system the input data can be data indicating the existence and location of a fault in a structure. The output data can be data indicating the vibration at a portion(s) of the structure. The computer can output data, including data indicating the existence and/or location of a fault in a structure, using a monitor or other display and/or a computer-readable medium. Furthermore, the computer can transmit such data to another computer via network or other media. The computer can be one of numerous commercially-available devices, including a personal computer (e.g., desk top, lap top, or notebook), personal digital assistant (PDA), microcontroller-based device, field programmable-logic array (FPGA), programmed array logic (PAL), programmed logic array (PLA), or other “intelligent” device. For example, the computer can comprise a Pentium® I-IV series or Celeron® microprocessor from Intel® Corporation, Santa Clara, Calif. Such microprocessor can execute computer instructions at virtually any master clock frequency, such as 33 megahertz to 1.8 gigahertz or higher. The computer can comprise memory such as read-only memory (ROM), random access memory (RAM) (including static RAM (SRAM), dynamic RAM (DRAM), synchronous dynamic RAM (SDRAM), or Rambus® dynamic RAM (RDRAM)). The computer can comprise memory in the form of a hard disk drive unit. Such memory(ies) can be from one (1) megabyte to eighty (80) gigabyte or more, for example. The computer can comprise a display with virtually any sized screen, such as a 15×13.8 inch, 17×16 inch, 19×18 inch, 22×20 inch color or monochrome screen, or a smaller display such as those used in PDAs, cellular telephones, hand-held web-browsers, and other hand-held devices. Such display can comprise a video graphics array (VGA), super video graphics card (SVGA), or extended graphics array (XGA) graphics card. The monitor can be used to display the structure and the existence and location of a fault. The computer can comprise one or more interface units such as universal serial bus (USB) ports or network interface cards (NICs), for example. The computer can comprise drive units such as 3.5-inch diskette, compact disc (CD), or digital versatile disc (DVD) drives to write data indicating existence and location of a fault onto a computer-readable medium. Software can include Windows® 3.0 or higher version, Windows® 1995, 1998, 2000, NT, CE, or XP operating system from Microsoft® Corporation, Redmond, Wash. The Palm® OS operating system for PDAs from Palm® Corporation, Santa Clara, Calif. The computer can be a laptop such as those sold under the trademarks Inspiron® or Latitude® from Dell® Corporation.

“Coupled” can be used in an electronic sense to refer to joining electronic elements together with a conductive line such as a wire or cable, or by transmission of signals through air, water, space, or other transmission media, for example. “Coupled” can be used in an optical sense to refer to joining optical elements together with an optical fiber, optical cable, or other optical waveguide, or by transmission through air, water, space, or other media, for example. “Coupled” in a mechanical sense can refer to joining two or more objects together by integral formation or by an adhesive, welding, braising, or by mechanical devices such as pins, rivets, bolts, screws, nails, etc.

“Fault” can be damage or deterioration of one or more structure elements, a dislocation or separation between structure elements normally joined, or an improper joining of structure elements. A fault can be caused by exposure to weather, e.g., rain, snow, sleet, wind, or extreme temperatures, either hot or cold. Alternatively, such fault can be due to an environmental phenomenon such as a groundquake or ground tremor, tornado, hurricane, flood, tide, wave, or other natural cause. As yet other possibilities for its cause, a fault can be due to error in design, material selection, or construction of the structure.

“Ground vibrator” is a device that generates seismic vibrations. Such ground vibrator can be a motor-, pneumatically-, hydraulically, or manually-driven device, for example. Such device can comprise a driven hammer or weight that strikes the ground to generate vibrations therein. Such vibrations travel through the ground to the structure to vibrate such structure to reveal the existence and/or location of a fault. Such ground vibrator can be obtained for purchase or lease from numerous commercial sources, including LandTech™ Enterprises, S.A., London, United Kingdom.

“Optical vibration sensor (OVS)” is a device that can be used to optically sense vibration of a structure. The OVS can be one of many models of laser vibrometers commercially available from Polytec® PI, Inc. Such models can include the OFV-303 OFV-353, OFV-511, OFV-512, OFV-1905 laser vibrometer commercially available from Polytec PI, Inc., of Auburn, Mass. and Tustin, Calif.

“Optical vibration sensor (OVS) controller” or “OVSC” can be a vibrometer controller such as model OFV-3001, OFV-2200, OFV-2601 series, OFV-2602, OFV-2700, OFV-3001.

“Optical element” refers to a lens, filter, or other optical conditioning device. Such optical element can be one of OFV-MR, OFV-SR or OFV-QR lenses commercially available from Polytec PI, Inc., of Auburn, Mass. and Tustin, Calif.

“Position controller” refers to a device operable by a person or computer to generate a control signal to pan and/or tilt the optical vibration sensor, based on control actions of the operator or a position control signal generated by the computer.

“Positioner” is an actuator device for tilting and/or panning an optical vibration sensor based on control signals from a position controller and/or computer, optionally under control of an operator. The positioner can be coupled between a tripod and a optical vibration sensor.

“Scan” refers to a process of moving a laser beam from portion to portion over a structure and optically sensing the reflected laser beam to take a set of vibration data readings indicating the vibration of the structure at respective portions thereof.

“Scan unit” is a unit capable of scanning a laser beam over a structure and of receiving reflected laser beam from portions of the structure to provide to a laser sensor head. The scan unit can be a device such as the model OFV-40 and OFV-055 commercially available from Polytec PI, Inc., of Auburn, Mass. and Tustin, Calif.

“Structure” can be a building, house, townhouse, condominium, office complex, warehouse, or storage facility, for example.

“Structure element” can be a foundation, roof, ceiling, floor, wall, beam, column, support, joist, wall, wall panel such as dry wall, wall frame, window, window frame, duct, plumbing, piping, hangers, or other element used in the construction or renovation of a building, house, or other structure.

“Vibration signal” or “vibration data” refer to data indicating vibration of one or more portions of a structure.

2. General System and Method

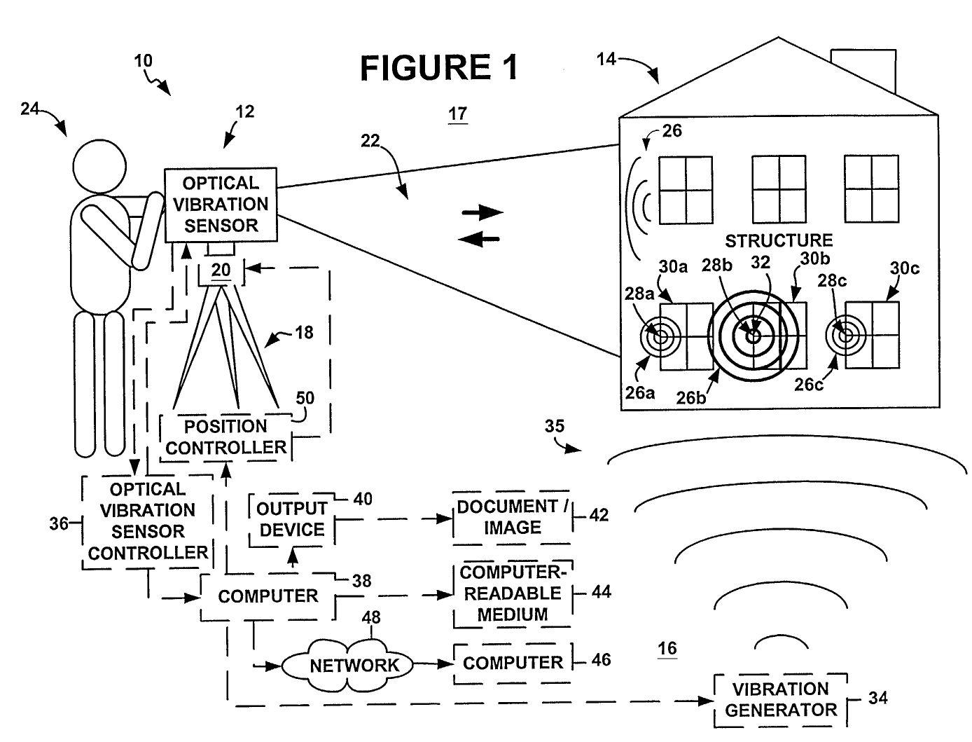

FIG. 1 is a system 10 comprising an optical vibration sensor (OVS) 12. The OVS 12 is positioned in proximity to a structure 14 to optically sense vibration from such structure. To position and support the OVS 12 on ground 16, the system 10 can comprise a tripod 18 coupled to the OVS 12. The system 10 can also comprise a positioner 20 that can be coupled between the OVS 12 and tripod 18. The positioner 20 can be a mechanical device or an automatic device such as a pan/tilt head, usable to align the OVS 12 relative to structure 14.

The OVS 12 can be a laser vibrometer or other device capable of optically sensing vibration 26 of the structure 14. The OVS 12 can be configured to direct a laser beam at a portion of the structure 14. The laser beam reflects back from the portion of the structure 14, and is Doppler-shifted by the vibration at the portion of the structure 14 to which the laser beam is incident. The Doppler-shifted laser beam reflected from the structure 14 is received by the OVS 12. The OVS 12 generates an OVS signal based on the Doppler-shifted laser beam. The OVS 12 can comprise a scan unit to scan the laser beam over the structure 14 so that the OVS signal includes signal components corresponding to vibrations at respective portions of the structure. The scan unit can move the laser beam in a pattern over the structure 14. The intervals between positions of the laser beam scan pattern can be within millimeters or centimeters of one another, for example.

The system 10 can comprise optical vibration sensor controller (OVSC) 36, computer 38, output device 40, and position controller 50. The OVSC 36 is coupled to receive the OVS signal from the OVS 12, and generates a vibration signal based thereon. More specifically, the OVSC 36 determines the peak velocity and/or displacement of the Doppler-shifted laser beam 22 from a respective portion(s) of the structure 14, using the OVS signal. To perform this function, the OVSC 36 can filter the Doppler-shifted laser beam 22 to extract frequency components corresponding to the laser beam after Doppler-shifting by the vibration at the portion of the structure from which the laser beam was reflected. The frequencies of vibration of the structure 14 are generally relatively low, e.g., at frequencies below 100 Hertz. The OVSC 36 monitors the OVS signal to determine the time period between maximum and minimum frequencies therein. This time period is proportional to the structure vibration frequency ƒ at the portion of the structure 14 from which the Doppler-shifted laser beam 22 is reflected. The peak velocity of the vibration ν can be determined by the minimum and/or maximum Doppler-shifted wavelength λₘₐₓ, λₘᵢₙ of the laser beam 22, as compared to the unshifted laser beam wavelength according to the equation:

νₚₑₐₖ=C(λ_{o-λ}_{ν)/λ}ₒ (1)

in which νₚₑₐₖ is the peak velocity of the vibration of the structure's portion, c is the speed of light in the medium (generally, air) in which the laser beam 22 travels from the OVS 12 to the structure 14 and back, λₒ is the wavelength of the laser beam 22 generated by the OVS 12, and λ_{ν} is the minimum or maximum wavelength of the Doppler-shifted laser beam received by the OVS 12 from the structure 14. The peak displacement of the vibration A from a portion of the structure 14 can be obtained from the following equation:

ν/2πƒ=A sin(2πƒτ+φ) (2)

in which ν is the velocity of the structure vibration at the portion thereof from which the Doppler-shifted laser beam 22 is received, ƒ is the frequency of the vibration, A is the peak displacement of the vibration, τ is time, and φ is the phase constant. Because the displacement A of the vibration is maximum if sin(2πƒτ) is equal to one, the peak velocity Vₚₑₐₖ is given by:

A=νₚₑₐₖ/2πƒ (3)

The OVSC 36 can thus be programmed to generate a vibration signal (or vibration data) indicating the peak displacement and/or peak velocity of the respective portion(s) of the structure 14 based on the OVS signal.

The computer 38 can be coupled to receive the vibration signal from the OVSC 36. The computer 38 can use the vibration signal to determine whether a fault exists in the structure at a portion(s) thereof from which the vibration signal is obtained. The computer 38 can perform this function using at least one of three methods: (1) the “threshold” method; (2) the “comparison” method; and (3) the “base line” method. In the “threshold” method, the computer 38 retrieves threshold data previously stored in its memory. The computer 38 compares the vibration data with the threshold data. If the computer 38 determines that the vibration data exceeds the threshold data, the computer generates fault data indicating that a fault exists in the structure at the position of structure portion from which the respective vibration data was obtained. Conversely, if the computer 38 determines that the threshold data equals or is less than the vibration data, the computer generates data indicating no fault exists in the structure at the portion thereof from which the vibration data was obtained. The computer 38 can repeat this method for the vibration data contained within a complete scan performed by the OVS 12. In the comparison method, the computer 38 receives the vibration data from the OVS 12 and/or OVSC 36, and compares the vibration data from similar portions of the structure 14. Through pattern recognition techniques, the computer can be programmed to determine portions of the structure with similar elements for comparison of their vibration data. Alternatively, the computer 38 can generate a display of the vibration data that reveals the structure 14 so that the operator 26 can perform the comparison of vibration data from similar portions of the structure. If the computer 38 and/or operator 24 determines that the vibration data from similar portions of the structure differ by more than a threshold data amount, the computer 38 and/or operator 24 conclude that a fault exists at the structure portion with the larger vibration. The computer 38 can also be used in the performance of the base line method. In this method, the computer 38 receives and stores as base line data the vibration data for a scan of the OVS 12. At a later time, the computer 38 receives and compares vibration data from the structure 14 with the base line data. Alternatively, the computer 38 can generate a display of the after-acquired data and base line data, that the operator 24 uses to perform comparison of the vibration data. If the vibration data of the after-acquired data exceeds the base line data, the computer 38 and/or operator 24 determines that a fault exists in the structure for the respective portion(s) thereof from which the compared vibration data was received. The computer 38 can be coupled to output vibration data, including fault data, if any, to the output device 40, optionally in response to the operator's control actions. The output device 40 can use this vibration data and/or fault data to generate a document/image 42 of the structure and vibration of portions thereof. The output device 40 can be a printer, for example, and the document/image can be paper or other substrate. Optionally, the computer 38 can be coupled to supply vibration data and/or fault data to a computer-readable medium 44. The document/image and/or computer-readable medium 44 can be included in a report, for example, to the owner of the structure or other interested party regarding any faults located in the structure. Furthermore, the computer 38 can be coupled via network 48 to another computer 46. The computer 38 can transmit the vibration data to the computer 46 via network 48 to report the vibration data received from the structure.

As shown in FIG. 1, the vibrations 26a, 26b, 26c can be sensed passively from the structure 14. Alternatively, the system 10 can comprise a vibration generator 34 to actively generate vibrations 35 to vibrate the structure 14. The vibration generator 34 can generate the vibrations 35 as waves traveling through ground 16 and/or air 17. The vibrations 35 travel to and vibrate the structure 14 to generate vibrations 26 for detection by the OVS 12. To actively induce vibrations 26 in the structure 14, the computer 38 can be coupled to the vibration generator 34 for control thereof. More specifically, the computer 38 generates a vibration control signal and is coupled to supply this signal to the vibration generator 34. The vibration generator 34 generates vibrations 35 supplied to the structure 14. The vibrations 35 cause the structure 14 to produce vibrations 26 detected by the OVS 12. The computer 38 can thus control active inducement of vibrations 26 in the structure 14 so that a fault in the structure 14 is more readily sensed by the OVS 12.

The computer 38 can also be coupled to a position controller 50. The computer 38 can generate a control signal supplied to the position controller 50. Based on the computer control signal, the position controller 50 generates a position control signal. The position controller 50 is coupled to supply the position control signal to the pan/tilt head 20. The pan/tilt head 20 controls the position of the OVS 12 relative to the structure 14, based on the position control signal. Hence, the computer 38 can move the OVS 12 to sense vibrations from different areas of the structure 14, optionally under control actions of the operator 26 provided to the computer via an input device thereof.

Upon determining the existence and location of a fault in the structure 14, the operator 24 can use chalk or an ink marker, for example, to mark on a surface of the structure 14 the location of the fault. Such marking can be used to later determine the location of the fault for repair and remediation, for example. Such repair and remediation are of course beyond the scope of this disclosure.

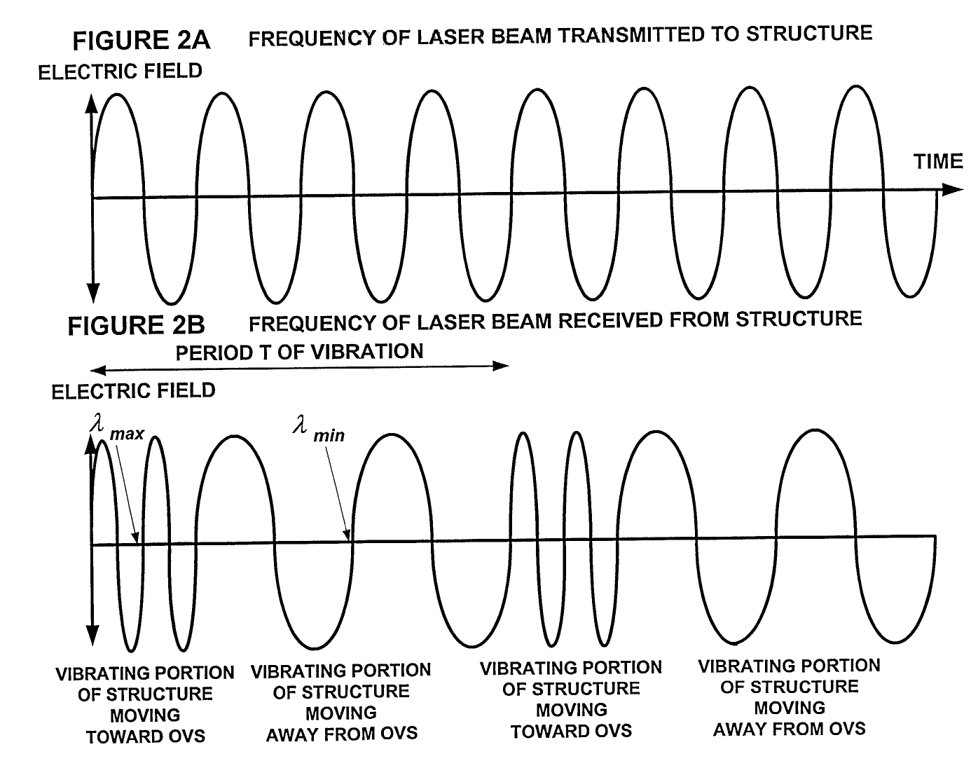

FIG. 2A indicates the frequency of the laser beam 22 transmitted to a structure 14. In FIG. 2B, the laser beam 22 reflected from the structure 14 is Doppler-shifted based on the vibration at the portion of the structure 14 from which such laser beam is reflected. More specifically, as the portion of the structure moves toward the OVS 12, the wavelength of the laser beam becomes relatively short as compared to the laser beam transmitted to the structure. Conversely, the laser beam 22 becomes relatively long as the portion of the structure 14 under vibration moves away from the OVS 12. The time period T between the maximum wavelength λₘₐₓ and the minimum wavelength λₘᵢₙ is the period of the vibration sensed at the portion of the structure 14. The vibration frequency ƒ of the corresponding portion of the structure is given by the relation ƒ=1/T.

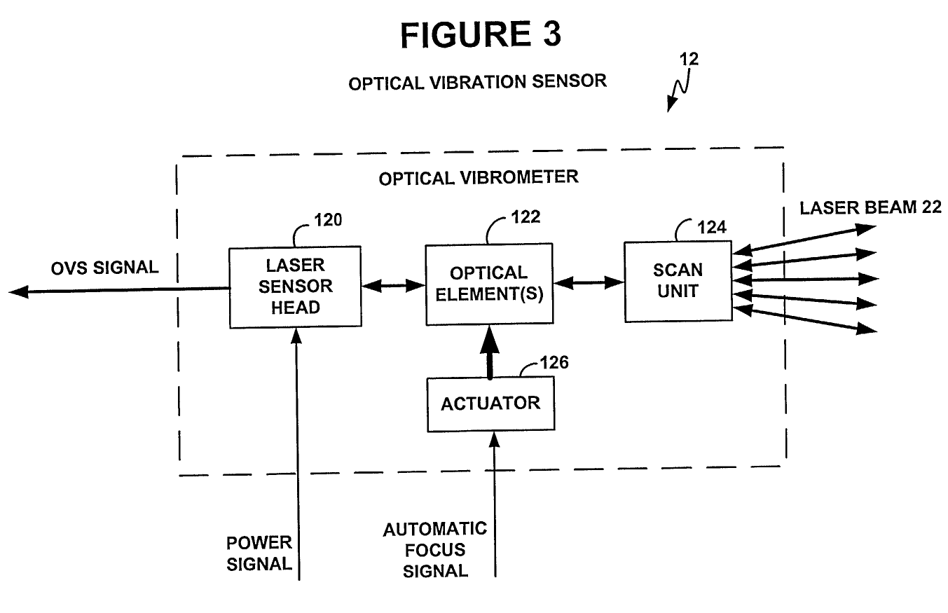

FIG. 3 is an example of the OVS 12 comprising laser/sensor head 120, optical element(s) 122, scan unit 124, and actuator 126. The laser/sensor head 120 can be coupled to receive a power signal used by the laser/sensor head to generate the laser beam 22. The power signal can be supplied directly from an external power source or may be supplied indirectly from such power source via another unit such as the OVS controller 36.

The laser beam 22 generated by the laser/sensor head 120 is supplied to optical element(s) 122 that conditions the laser beam 22. For example, the optical element(s) 122 can comprise one or more lenses to focus the laser beam 22 generated by the laser/sensor head 120 onto the structure 14. After conditioning by the optical element(s) 122 the laser beam 22 travels to the scan unit 124. The scan unit 124 can comprise one or more galvanometric deflection mirror unit(s) with corresponding electric control unit(s) for generating respective deflection control signal(s) to control the deflection of the mirror unit(s). The mirrors receive the laser beam 22 and their deflection scans the laser beam 22 over the structure 14, as represented schematically by the multiple beam paths shown in FIG. 3. From the scan unit 124 the laser beam 22 travels to a portion of the structure 14. The laser beam 22 reflects from the structure 14, and is Doppler-shifted by an amount corresponding to the vibration of the structure 14 at the portion thereof to which the laser beam 22 is incident. The laser beam 22 reflects from the portion of the structure 14 back through the scan unit 124, optical elements 122, and laser/sensor head 120, and is output from the OVS 12 as the OVS signal. For automatic focus, the actuator 126 can be coupled to receive an automatic focus signal from the computer 38. The computer 38 can generate the automatic focus signal in response to the operator's control actions, or based on the OVS and/or OVSC signal received from the units 12, 36. Based on the automatic focus signal, the actuator 126 controls positioning of the optical element(s) 122 relative to the laser/sensor head 120 and structure 14 to achieve focus of the laser beam 22 on the structure 14.

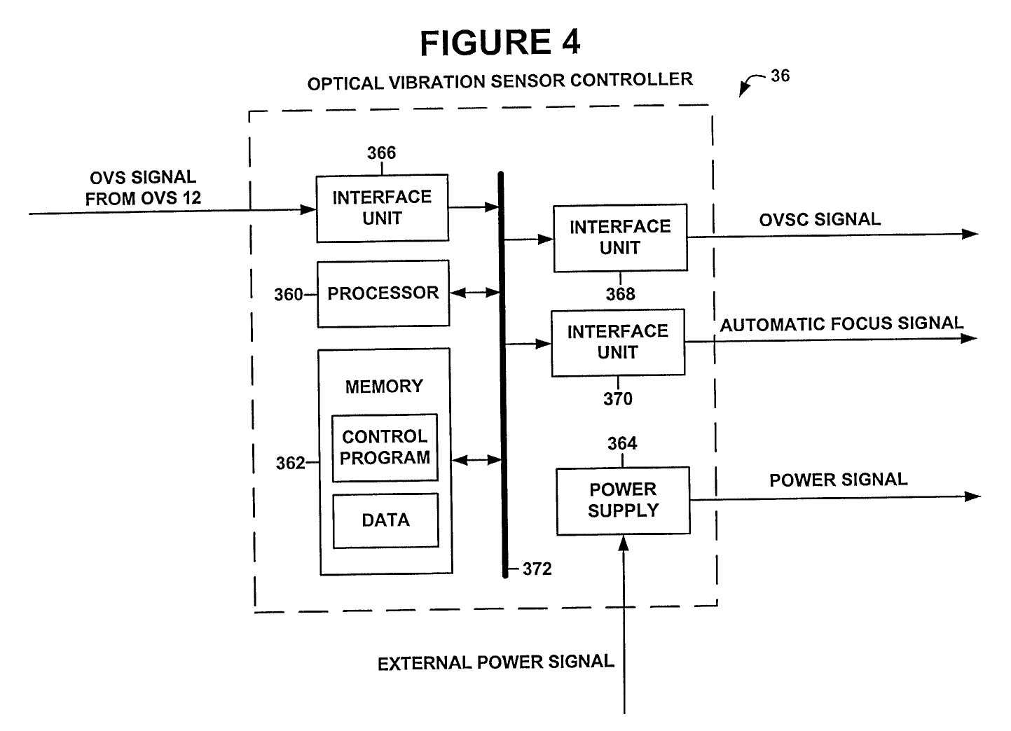

FIG. 4 is an exemplary embodiment of the OVSC 36. The OVSC 36 comprises a processor 360, a memory 362, a power supply 364, and interface units 366, 368, 370 coupled to the bus 372. The interface unit 366 is coupled to receive the OVS signal from the OVS 12. The interface unit 366 can comprise an optical-to-electrical (O/E) converter coupled to receive the OVS signal and convert such signal into electric form, e.g., a voltage or digital data representative of such voltage. The processor 360 executes control program stored in memory 362. The processor 360 can execute the control program to perform its functions. More specifically, the processor 360 executes the control program, causing it to sample the OVS signal received from the interface unit 366 via bus 370. The processor 360 can store the sampled OVS signal as vibration data in the memory 362. The processor 360 can further execute the control program using the stored sample data to determine the peak displacement and/or velocity of the vibration from the portion of the structure 14. The determined peak displacement and/or velocity of the vibration from the portion of the structure 14 to which the vibration pertains can be stored in the memory 362 along with index data to identify the portion of the structure from which the vibration data was obtained. Alternatively, such index can be represented by the address of the memory location at which vibration data is stored. The processor 360 can repeat this operation for portion of the structure from which data is obtained over a scan of the structure. Further, the processor 260 can repeat the above-stated operations for a plurality of scans to produce vibration data for respective scans. The processor 360 can scale the vibration data to a particular maximum range, e.g., 0-5, 0-25, or 0-125 millimeter per second per Volt for peak velocity or 0, 0.5, 2, 8, or 20 micrometer per Volt. Hence, the voltage represented by the vibration data represents the peak displacement or velocity of the vibration from the illuminated portion of the structure. The processor 360 can output the vibration data as the OVSC signal via bus 370 and interface unit 368. Interface unit 368 can provide scalar multiplication, electrical-to-optical (O/E) conversion, and/or data format conversion, to produce the OVSC signal in a form usable by the computer 38. The OVSC 36 can comprise a power supply 364 coupled to receive an external power signal such as a standard 120 or 220 Volt wall or generator outlet source. The power supply 364 can comprise a voltage regulator to steady the power supplied to the laser/sensor head 120. Furthermore, the power supply 364 can comprise a transformer to convert the voltage and current of the external power signal, into a voltage and current compatible with the laser included in the laser/sensor head 120. Based on the OVS signal, the processor 360 can execute the control program to generate an automatic focus signal. The automatic focus signal can be supplied to the interface unit 370. The interface unit 370 is coupled to supply the automatic focus signal to the actuator 126 of the OVS 12.

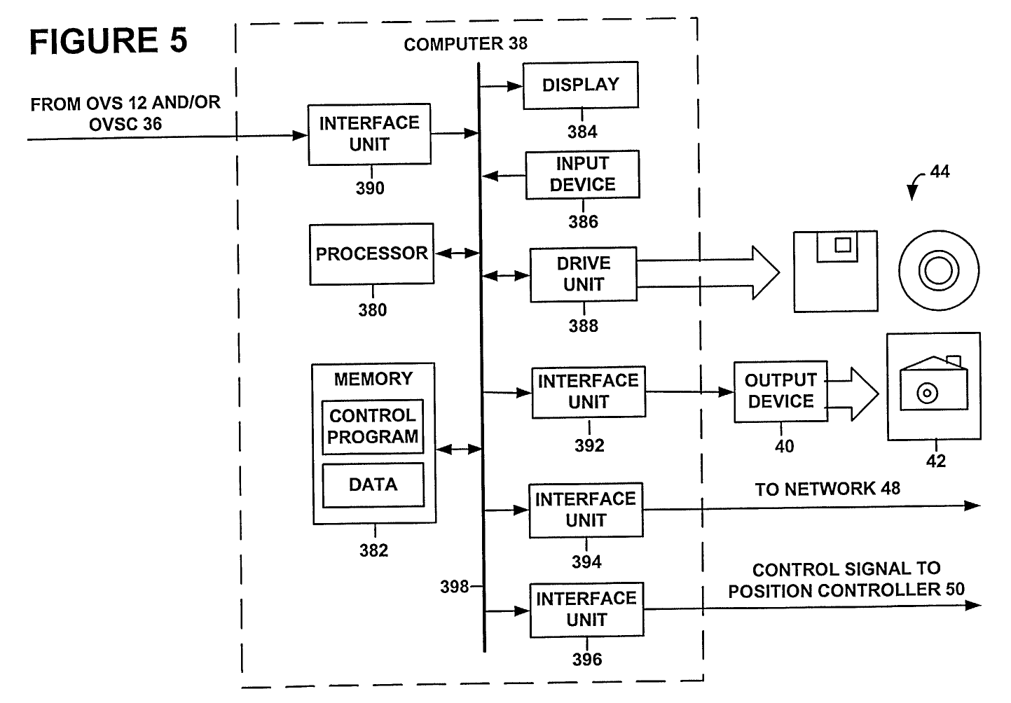

FIG. 5 is an example of a computer 38 of FIG. 2 in accordance with the invention. The computer 38 of FIG. 5 comprises processor 380, memory 382, display 384, input device 386, drive unit 388, and interface units 390, 392, 394, 396. The processor 380 executes a control program stored in memory 382 to perform its fictions. More specifically, the processor 380 executes the control program to retrieve the OVS or OVSC signal via the interface unit 390. The interface unit 390 can comprise an O/E converter and/or analog-to-digital (A/D) converter, for example, to convert the OVS or OVSC signal into a form usable by the processor 380. The interface unit 390 receives the OVS or OVSC signal and stores this signal as vibration data in the memory 382. The processor 380 can execute the control program using the vibration data to determine whether a fault exists in the structure, and if so, the location of such fault in the structure. The processor 380 can generate a display of the vibration data from the structure 14 including any fault therein, on the display 384. The processor 380 can also output vibration data for the structure 14 in hard copy or paper format on image/document 42 via interface unit 392 and output device 40. The interface unit 392 converts vibration data from the memory 382 output via processor 380, into a form usable by the output device 40. The output device 40 can be a printer of like device, which generates the image/document 42 based on the received vibration data. The processor 380 can write the vibration data including data indicating the existence and location of any fault in the structure, to the computer-readable medium 44, e.g., a CD-ROM, diskette, or other computer-readable medium. The processor 380 can also be coupled to supply the vibration data including data indicating the existence and/or location of any fault in the structure, to the network 48. Input device 386 such as a key board, mouse, joystick or other device, can be used by the operator 24 to generate a position control signal received by the processor 380. The processor 360 supplies the position control signal to the interface unit 396. The interface unit 396 is coupled to supply the position control signal to the position controller 50. Based on the position control signal, the position controller 50 generates a control signal supplied to the positioner 20 to, for example, pan and/or tilt the OVS 12 relative to the structure 14.

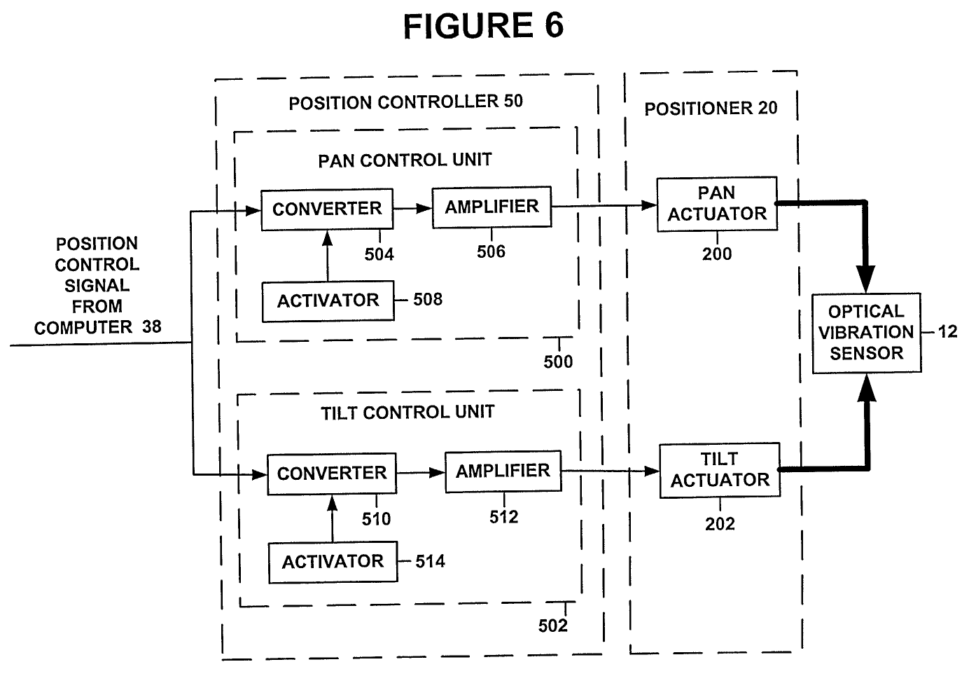

FIG. 6 is an example of the position controller 50 and positioner 20 used to control the position of the OVS 12 relative to the structure 14. The position controller 50 can comprise a pan control unit 500 and a tilt control unit 502. The pan control unit 500 and tilt control unit 502, are coupled to receive the position control signal from the computer 38. Based on the position control signal, the pan control unit 500 generates a pan control signal. More specifically, the converter 504 is coupled to receive the position control signal from the computer 38. Based on the control signal, the converter 504 generates a converted signal. The converter 504 is coupled to supply the converted signal to the amplifier 506 that generates the pan control signal output from the position controller 50. The converter 510 is coupled to receive the position control signal from the computer 38. Based on the position control signal, the converter 510 generates a converted signal. The converter 510 is coupled to supply the converted signal to the amplifier 512. The amplifier 512 receives and amplifies the converted signal to generate the tilt control signal output from the tilt control unit 502.

Still referring to FIG. 6, the positioner 20 is coupled to receive the pan control signal and tilt control signal from the position controller 50. More specifically, the pan actuator 200 is coupled to receive the pan control signal from the amplifier 506 and controls the pan position of the OVS 12 relative to the structure 14 through application of motive force, based on the pan control signal. The tilt actuator 202 is coupled to receive the tilt control signal from the amplifier 512 and controls the tilt position of the OVS 12 through application of motive force, based on the tilt control signal. The position controller 50 and positioner 20 can thus be used to orient or align the OVS 12 relative to the structure 14 so that vibrations can be optically sensed therefrom.

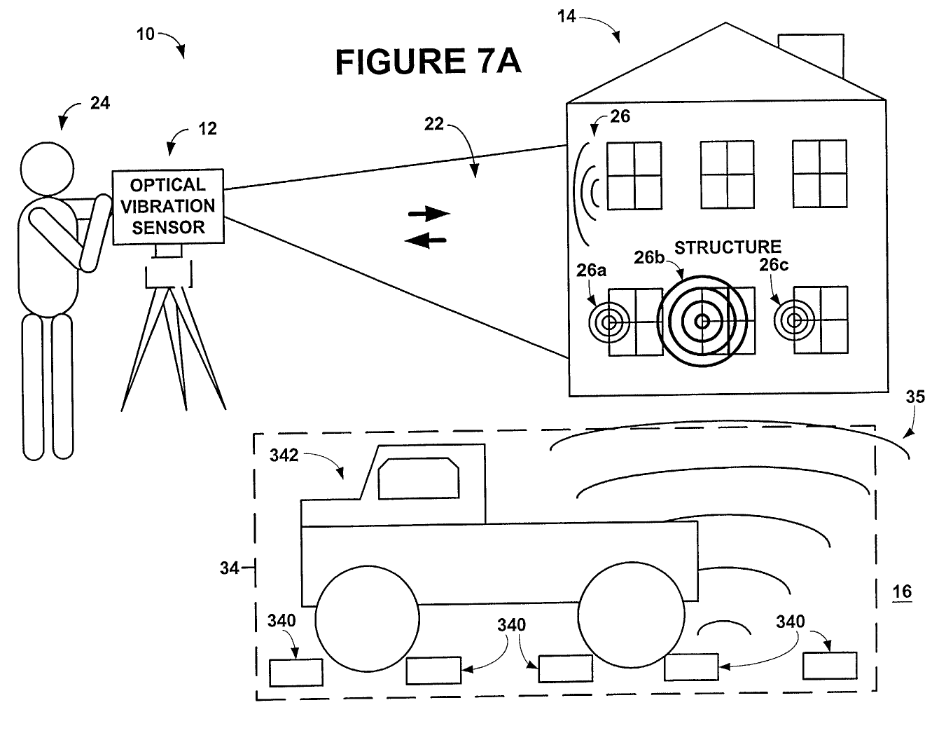

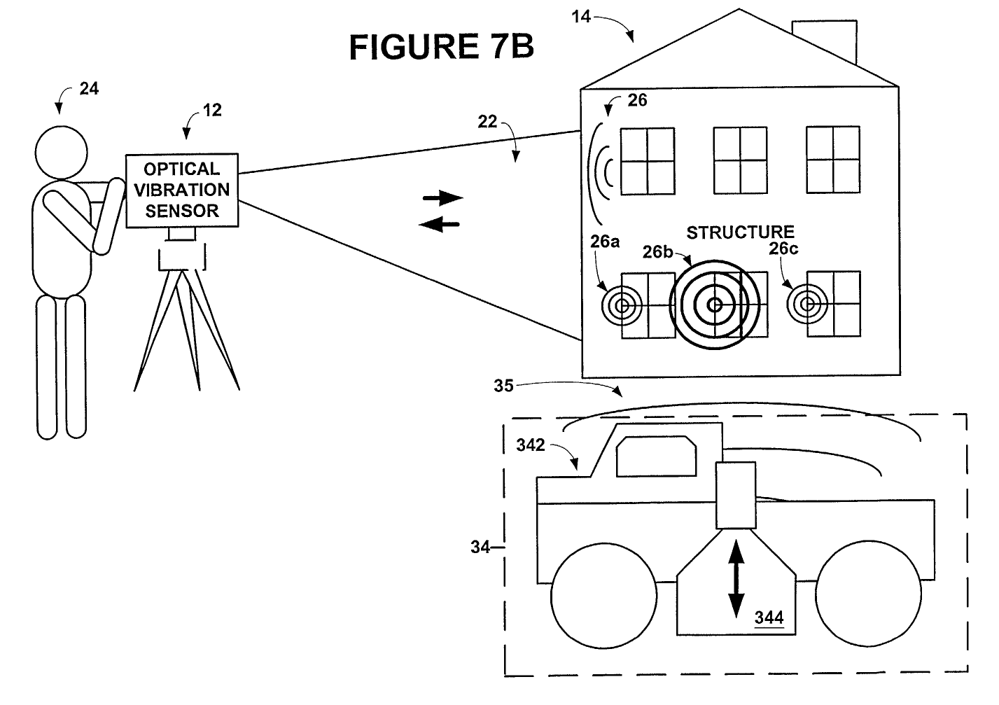

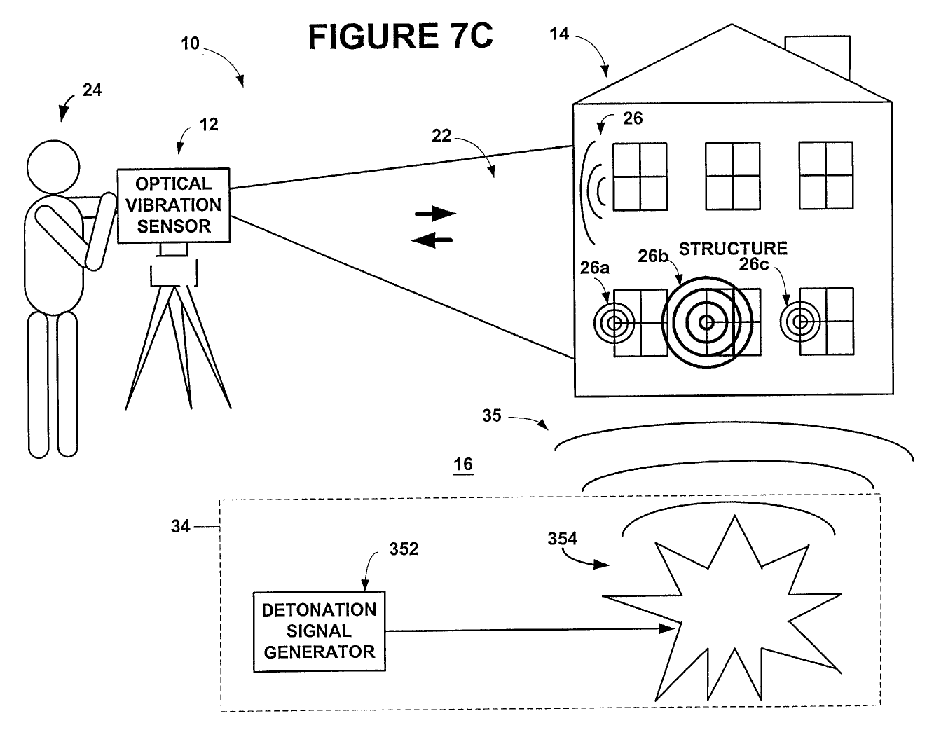

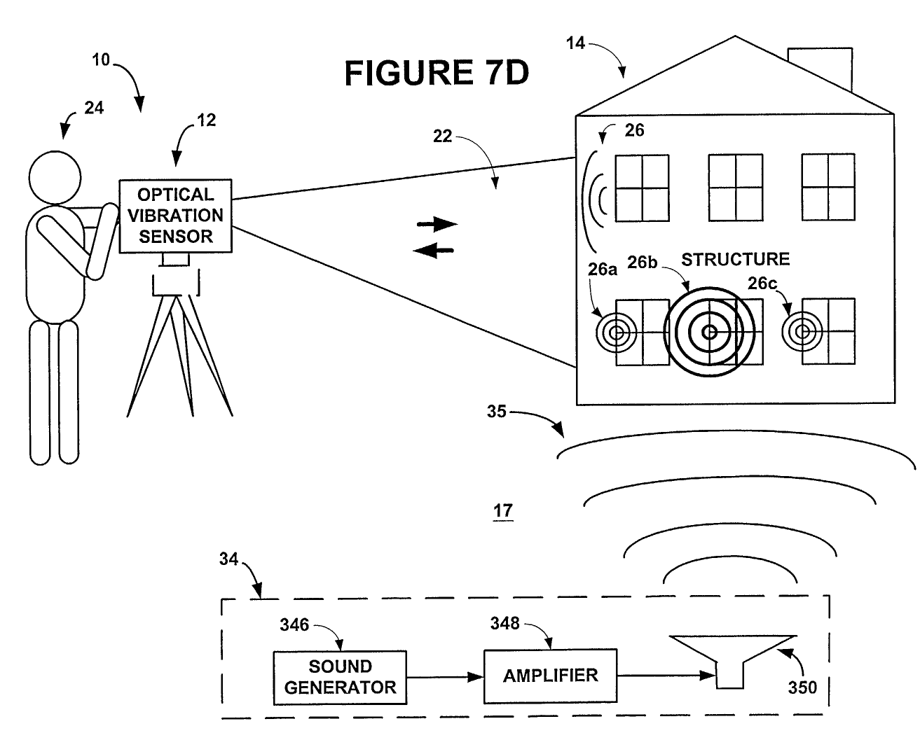

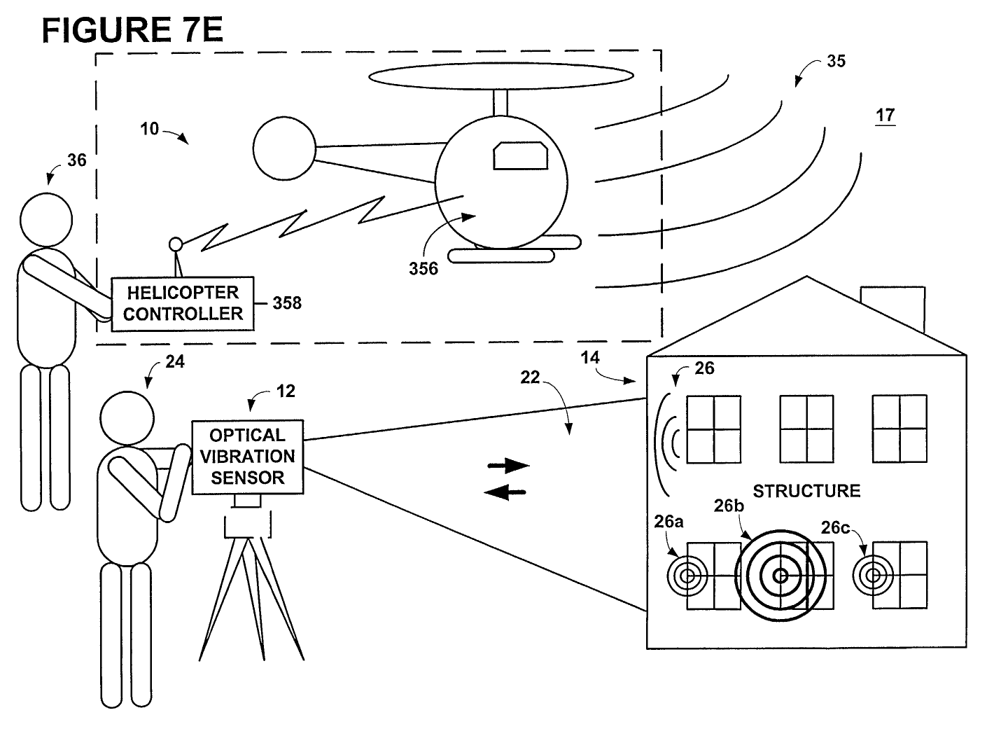

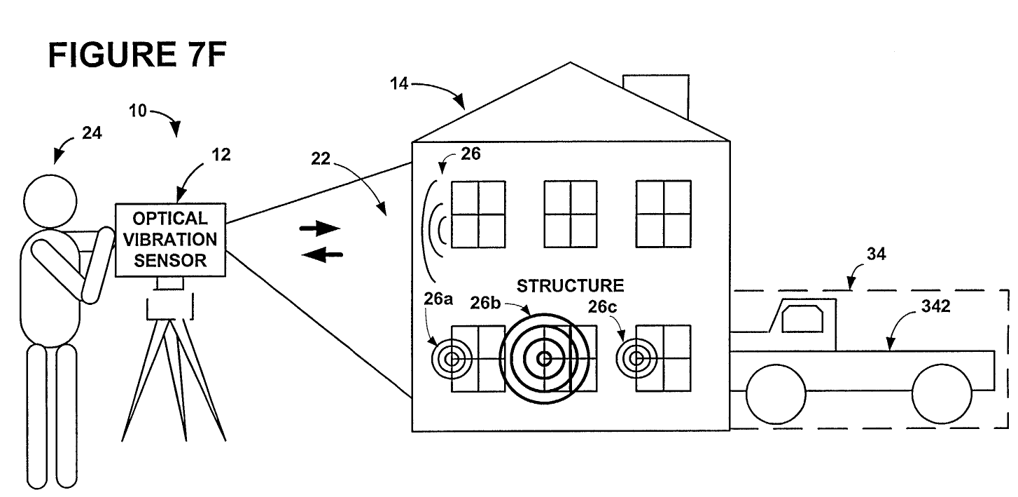

FIG. 7A is a version of the vibration generator 34 comprising objects 340 and vehicle 342. The objects 340 are positioned on the ground 16 in proximity to the structure 14. The vehicle 342 is driven over the objects 340 to generate the vibrations 35 in the ground 16. Such ground vibrations 35 travel through the ground 16 to vibrate the structure 14. The vibration of the structure 14 generates vibrations 26 that can be optically sensed by OVS 12 to determine whether a fault exists in the structure 14.

FIG. 7B is a version of the vibration generator 34 comprising the vehicle 342 with mounted vibration unit 344. The vehicle 342 and vibration unit 344 are positioned in proximity to the structure 14 The vibration unit 344 can comprise a motor-, hydraulically-driven, pneumatically-driven, or manually-driven weight or hammer that generates vibrations 35 in the ground 16. The vibration 35 causes the structure 14 to vibrate so that the OVS 12 can optically sense the vibrations 26 from respective portions of the structure 14.

FIG. 7C is a version of the vibration generator 34 comprising a detonation signal generator 352 and explosive 354. The detonation signal generator 352 can be operated by the operator 24 to generate a detonation signal. The detonation signal generator 352 is coupled to supply the detonation signal to the explosive 354 that explodes, generating vibrations 35 that travel through ground 16 to structure 14. The OVS 12 can optically sense vibrations 26 from the structure 14, to determine the existence of any fault therein.

FIG. 7D is a version of the vibration generator 34 comprising a sound generator 346, an amplifier 348, and a speaker 350. The sound generator 346 generates a sound signal, and is coupled to supply this signal to the amplifier 348. The amplifier 348 generates an amplified signal and is coupled to supply this signal to the speaker 350. The speaker 350 converts the amplified signal into sonic vibrations 35 that travel through air 17 to the structure 14. The structure 14 vibrates under the sonic energy from the vibrations 35. The OVS 12 can optically-sense vibrations 26 from respective portions of the structure to determine whether a fault is present therein.

FIG. 7E is a version of the vibration generator 34 comprising a remote-controlled helicopter 356 and a helicopter controller 358. Operator 360 can use the helicopter controller 358 to generate a control signal in the form of radio waves received by the helicopter 356 for control thereof. Using the helicopter controller 358, the helicopter 356 can be positioned in proximity to the structure 14 and used to generate vibrations 35 that travel through the air 17 to the structure 14. The structure 14 is thus vibrated so that the OVS 12 can optically sense vibrations 26 from the structure 14.

FIG. 7F is a version of the vibration generator 34 comprising vehicle 342. The vehicle 342 can be used to contact and apply force to the structure 14 for vibration thereof. The OVS 12 can optically sense resulting vibrations 26 to determine the existence and location of a fault within the structure 14.

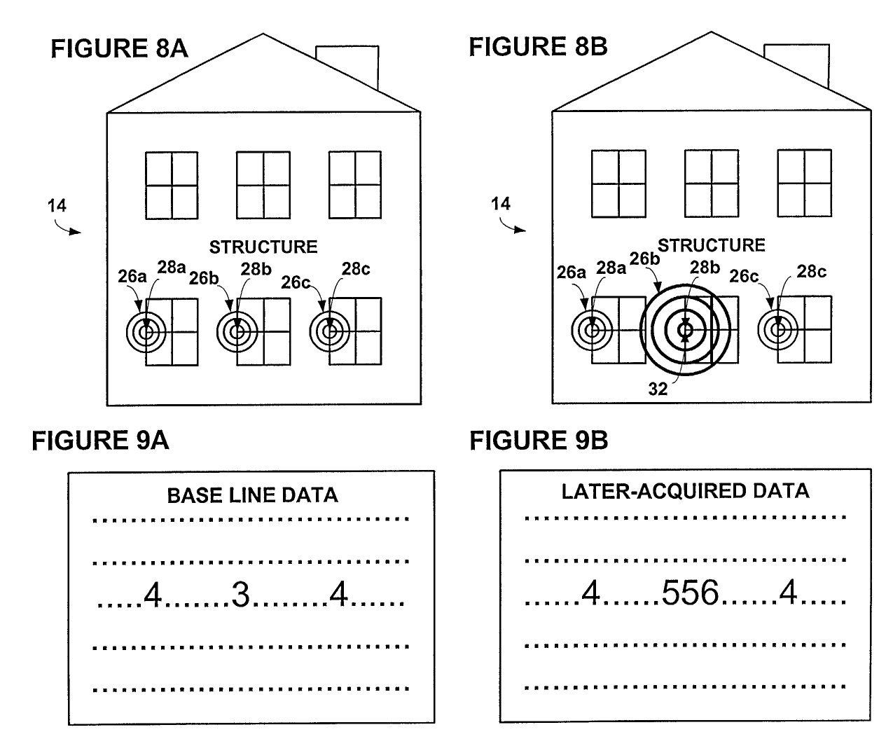

FIGS. 8A, 8B, 9A, 9B exemplify the “base line” method for detecting a fault in a structure. The OVS 12 optically senses vibrations 26a, 26b, 26c (and possibly other vibrations) from respective portions of the structure 14, and produces vibration data based thereon. This vibration data as stored in memory 382 of computer 38 as base line data, as shown in the example of FIG. 9A. The base line data includes vibration data readings of “4”, “3”, “4”, for example, from respective portions 28a, 28b, 28c of the structure 14. The “•”s in FIGS. 8A and 8B represent the possibility that other vibration data from other portions of the structure 14, can be obtained by the OVS 12. The computer 38 can set the threshold data to be twice the highest level of the base line data, i.e., 2×4=8. The setting of the threshold data depends on the nature of the structure elements and their manner of incorporation in the structure. The threshold data can nonetheless be set on the basis of the relative vibration of structure elements containing a fault as opposed to structure elements not containing a fault, as determined through experimentation or experience with the materials composing the structure elements, as well as their construction. At a later time, generally on the order of minutes to years after sensing the base line vibration data, the OVS 12 again generates vibration data for the portions 28a, 28b, 28c, as shown in FIGS. 8B, 9B. This later-acquired vibration data is also stored in the memory 382 of the computer 38. The computer 38 compares the later-acquired data with the base line data. Although the vibration data for portions 28a, 28c do not exceed respective later-acquired data by more than the threshold data level of “8”, the vibration data “556” exceeds such threshold data level. Accordingly, computer 38 determines that a fault 32 exists at the portion 28b of the structure 14. Alternatively, the “base line” method can be applied by operator 24 through qualitative and/or quantitative comparison of visual or numerical data displayed by the computer 384 on the display 382, printed on document/image 42, or otherwise output from the computer 38 in human-readable form.

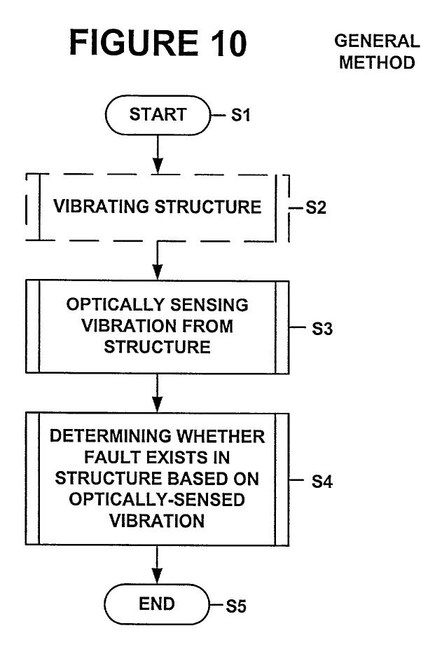

FIG. 10 is a general method of the invention. In step S1 the method of FIG. 10 begins. In step S2 the method comprises vibrating the structure 14. Step S2 can be performed by the vibration generator 34 that generates vibration 35 to induce the structure 14 to vibrate. Step S2 is optional, however, and the method can be performed without such step. In step S3 the method comprises optically sensing vibration 26 such as 26a, 26b, 26c from the structure 14. The optical sensing can be performed by the OVS 12. In step S4 the method comprises determining whether a fault 32 exists in the structure, based on the optically-sensed vibration. This step can be performed by the human operator 24 and/or computer 38. In step S5 the method of FIG. 10 ends.

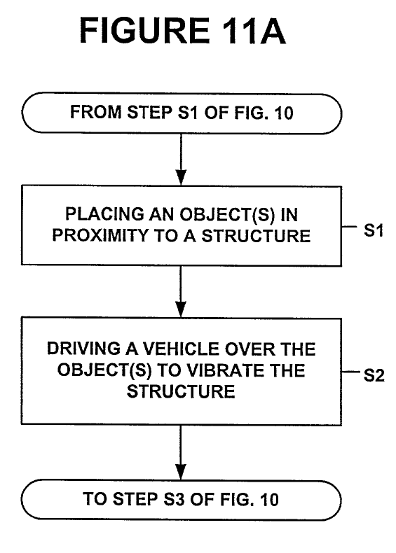

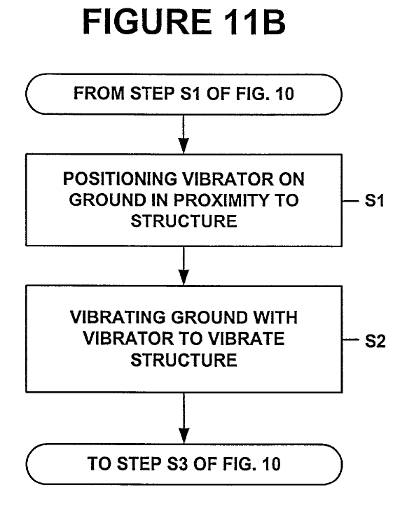

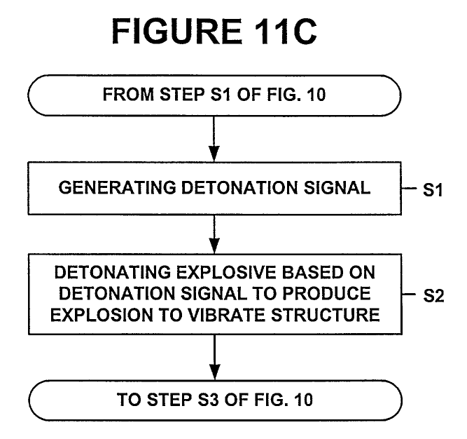

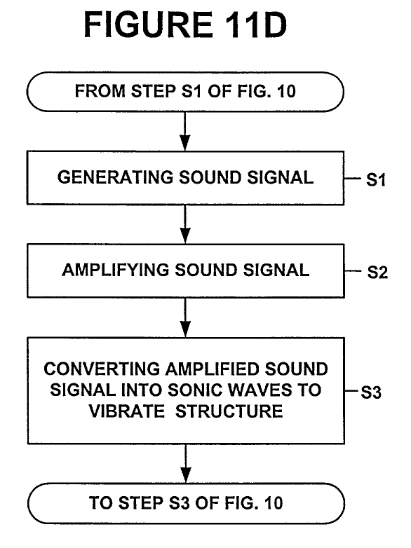

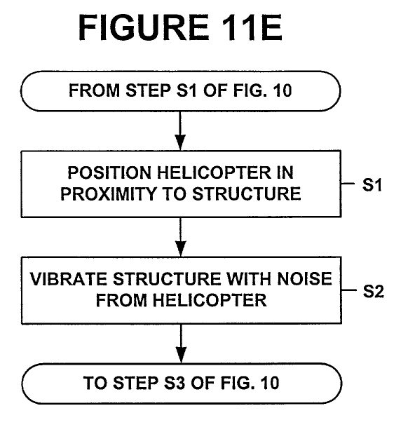

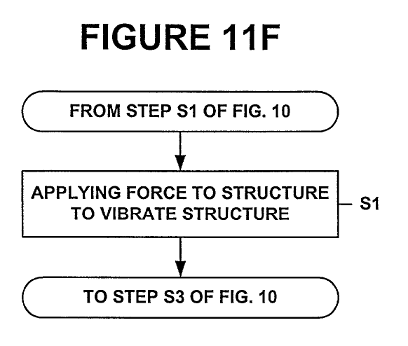

FIG. 11A is a first method used for vibrating the structure 14, and corresponds to Step S2 of FIG. 10. The method of FIG. 11A starts from Step S1 of FIG. 10. In step S1 the method of FIG. 11A comprises placing object(s) 340 in proximity to the structure 14. In Step S2 the method of FIG. 11A comprises driving the vehicle 342 over the object(s) 340 to vibrate the structure 14. In effect, the vehicle's lifting and falling as it drives over the object(s) 340 causes the ground 16 to vibrate, which in turn vibrates the structure 14. The vibration 35 should be sufficient in magnitude to permit the OVS 12 to optically sense any fault existing in the structure 14, such as the fault 42. The object(s) 340 should of course be placed in sufficiently close proximity to the structure 14 so that the vibration 35 produced by the vehicle 342 induces sufficient vibration in the structure to reveal any fault existing therein.

FIG. 11B is a second method for vibrating the structure 14, and corresponds to step S2 of FIG. 10. In step S1 the method comprises positioning the vibrator 344 in proximity to the structure 14. In step S2 the method comprises vibrating the ground 16 with the vibrator 344, to vibrate the structure 14 so that any fault present in the structure can be detected by the OVS 12. After performance of step S2 the method of FIG. 11B proceeds to the optical sensing of step S3 of FIG. 10.

FIG. 11C is a third method for vibrating the structure 14, and corresponds to step S2 of FIG. 10. The method of FIG. 11C starts from Step S1 of FIG. 10. In step S1 of FIG. 11C, the method comprises generating a detonation signal. In step S2 the method of FIG. 11C comprises detonating explosive 354 based on the detonation signal to produce an explosion to vibrate the structure 14. From Step S2 of FIG. 11C the method proceeds to the optical sensing of step S3 of FIG. 10.

FIG. 11D is a fourth method for vibrating the structure 14, and corresponds to step S2 of FIG. 10. In step S1 of FIG. 11D the method comprises generating the sound signal. This step can be performed, for example, by the sound generator 346 of FIG. 7D. In step S2 the method comprises amplifying the sound signal to generate an amplified sound signal. This step can be performed by the amplifier 348 of FIG. 7D. In step S3 the method of FIG. 11D comprises converting the amplified sound signal into sonic waves traveling to the structure 14 through the air 17 to vibrate the structure 14. This step can be performed by the speaker 350 of FIG. 7D. From step S3 of FIG. 11D the method can proceed to step S3 of FIG. 10.

FIG. 11E is a fifth method for vibrating the structure 14, and corresponds to step S2 of FIG. 10. From step S1 of FIG. 10, the method proceeds to step S1 of FIG. 11E. In step S1 of FIG. 11E the method comprises positioning the helicopter 356 in proximity to the structure 14. The helicopter 356 can be flown by a pilot (not shown) or controlled remotely by operator 360 using helicopter controller 358. In step S2 the method of FIG. 11E the method comprises vibrating the structure 14 with noise vibration 35 from the helicopter 356. The proximity of the helicopter 356 to the structure 14 and the magnitude of the noise vibration from the helicopter, induce vibration 26 in the structure 14. From step S2 the method of FIG. 11E proceeds to step S3 of FIG. 10.

FIG. 11F is a sixth method for vibrating the structure 14, and corresponds to step S1 of FIG. 10. From step S1 of FIG. 10, the method of FIG. 11F begins. In step S1 of FIG. 11F the method comprises applying force to the structure 14 to vibrate such structure. This step can be performed by contacting or bumping the structure 14 with the vehicle 342, for example. From step S1 of FIG. 11F the method proceeds to step S3 of FIG. 10.

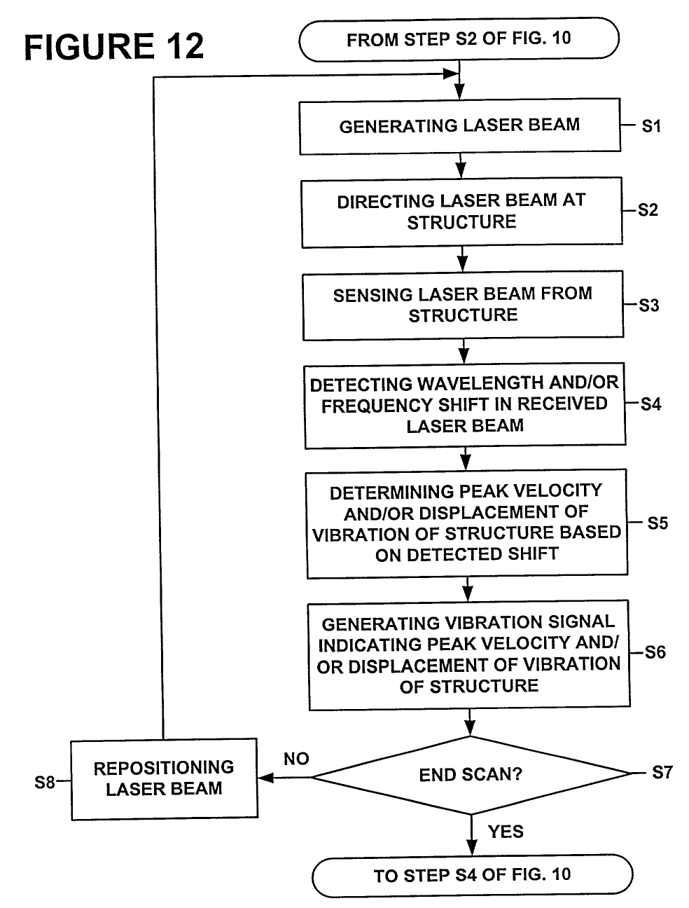

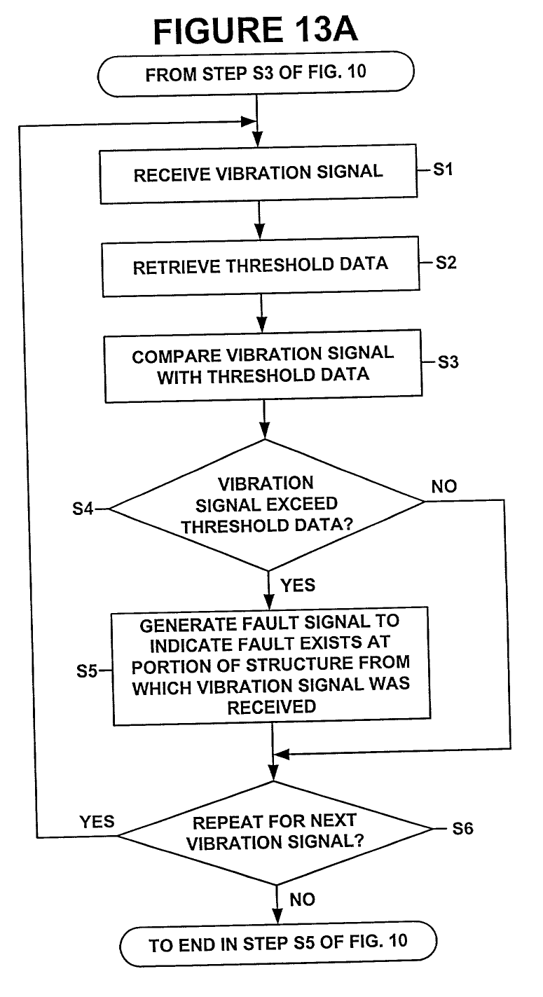

FIG. 12 is a method corresponding to step S3 of FIG. 10. From step S2 of FIG. 10, the method proceeds to step S1 of FIG. 12. In step S1 of FIG. 12 the method comprises generating a laser beam 22. In step S2 of FIG. 12 the method comprises directing the laser beam at the structure 14. The laser beam 22 travels to and is disturbed by a portion of the structure 14 in a manner proportional to the vibration 26 existing at such portion. In step S3 the method comprises sensing the laser beam from the structure 14. In step S4 the method comprises detecting wavelength and/or frequency shift the laser beam 22 reflected from the structure 14. Steps S1-S4 can be performed by the OVS 12. In step S5 the method comprises determining the peak velocity and/or displacement of the vibration 26 from the structure 14. In step S6 of FIG. 12 the method comprises generating the vibration signal or vibration data to indicate the peak velocity and/or peak displacement of the vibration 26 of the structure 14. In step S7 a determination is made to establish whether a scan of the structure 14 has been completed. Steps S4-S7 can be performed by the OVSC 36 and/or computer 38. If the determination in step S7 is negative, in step S8 the method comprises repositioning the laser. This step can be performed by the scan unit 124 of the OVS 12. Alternatively, this step can be performed by the position controller 50 and the positioner 20, optionally under control of the operator 24 and/or computer 38. From step S8 the method returns to step S1 of FIG. 12. If the determination in step S7 is affirmative, the method proceeds to step S4 of FIG. 10.

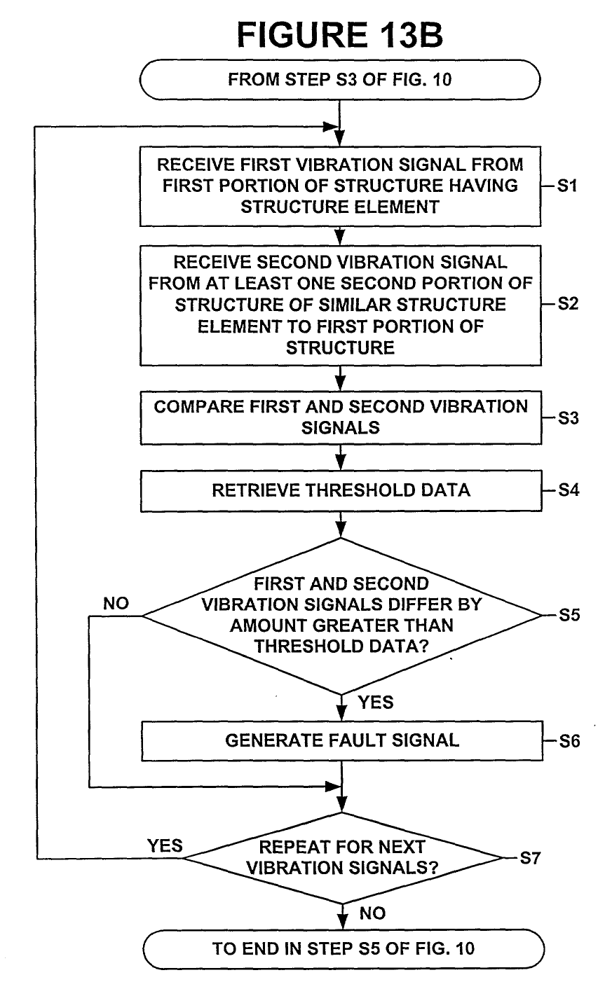

FIG. 13A is a “threshold” method for determining whether a fault exists in a structure based on optically sensed vibration from such structure. The method begins from step S3 of FIG. 10. In step S1 of FIG. 13A the method comprises receiving the vibration signal or data. In step S2 the method comprises retrieving threshold data. In step S3 the method comprises comparing the vibration signal or data with the threshold data. In step S4 the method comprises determining whether the vibration signal exceeds the threshold data. If the determination in step S4 is affirmative, in step S5 the method comprises generating a fault signal to indicate whether a fault exists at the portion of the structure 14 from which the vibration signal or data was received. After step S5 or if the determination in step S4 is negative, in step S6 of FIG. 13A the method comprises determining whether the method of FIG. 13A should be repeated for the vibration signal received from the next portion of the structure. If so, the method proceeds to step S1 of FIG. 13A. Conversely, if the determination in step S6 is negative, the method proceeds to step S5 of FIG. 10.

FIG. 13B is a “comparison” method for determining whether a fault exists in a structure. The method of FIG. 13B begins from the step S3 of FIG. 10. In step S1 of FIG. 13B the method comprises receiving first vibration signal or data from a first portion of the structure 14 having first structure element(s). In step S2 of FIG. 13B the method comprises receiving second vibration signal or data from at least one second portion of the structure of similar structure element(s) to the first portion of the structure. In step S3 the method comprises comparing the first and second vibration signals. In step S4 the method comprises retrieving threshold data. In step S4 the method comprises determining whether the first and second vibration signals or data differ by an amount greater than the threshold data. If the determination in step S5 is affirmative, in step S6 the method comprises generating the fault signal. After performance of step S6 of FIG. 13B or if the determination of Step S5 is negative, the method proceeds to step S7 in which a determination is made to establish whether the method should be repeated for the next corresponding vibration signal(s) or data. Such signal or data may be the next vibration reading in a scan of the laser beam 22 over the structure 14. If the determination in step S7 is affirmative, the method returns to step S1 of FIG. 13B and subsequent steps. Conversely, if the determination in step S7 is negative, the method proceeds to step S5 of FIG. 10.

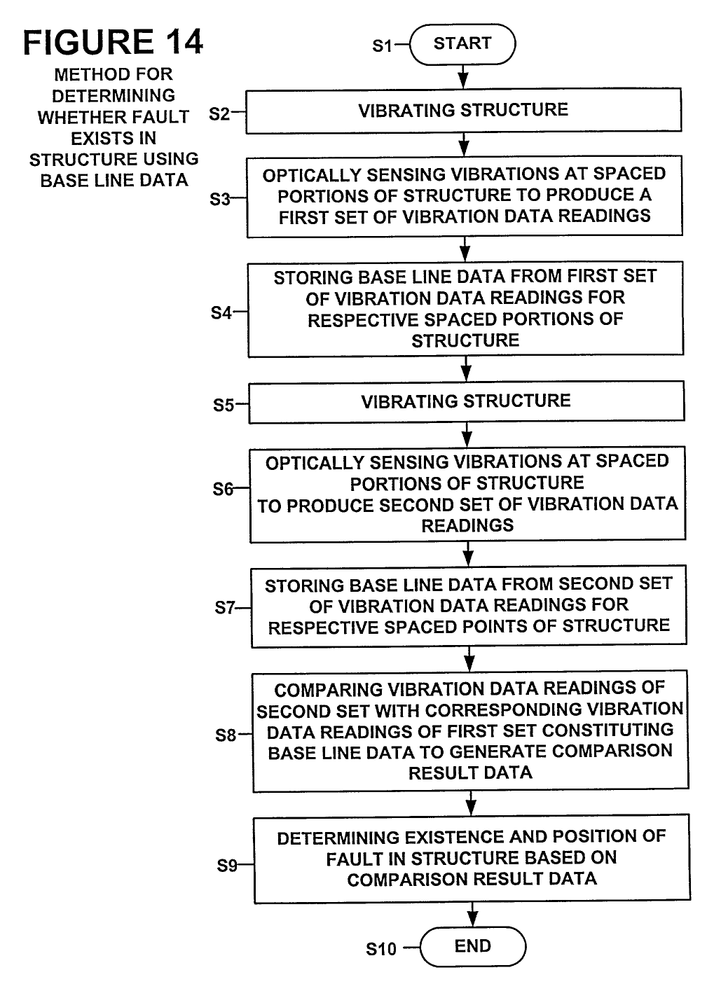

FIG. 14 is a “base line” method for determining whether a fault exists in a structure. In step S1 the method of FIG. 14 begins. In step S2 the method comprises vibrating the structure 14. Such step can be performed by the vibration generator 34. In step S3 the method comprises optically sensing vibration at spaced portions of the structure 14 to produce a first set of vibration data readings. Such step can be performed by the OVS 12, OVSC 36, and optionally computer 38. In step S4 the method comprises storing the base line data from the first set of vibration data readings for respective spaced portions of the structure 14. This step can be performed by the operator 24 and/or computer 38. In step S5 the method comprises vibrating the structure. This and subsequent steps can be, and generally are, performed a significant time, from minutes to years, after the establishment of the base line data. Such step can again be performed by the vibration generator 34. In step S6 the method comprises optically sensing vibrations at spaced portions of the structure 14 to produce a second set of vibration data readings. Such step can be performed by the OVS 12, OVSC 36, and optionally computer 38. In step S7 the method comprises storing baseline data from the second set of vibration data readings for respective spaced portions of the structure 14. Such step can be performed by the operator 24 and/or computer 38. In step S8 the method comprises comparing the vibration data readings of the second data set with corresponding vibration data readings of the first data set constituting the base line data, to generate comparison result data. Such step can be performed by the operator 24 and/or computer 38. In step S9 the method comprises determining whether a fault exists in the structure 14, and its location, based on the comparison result data. Such step can be performed by the operator 24 and/or computer 38. In step S10 the method of FIG. 14 ends.

In the foregoing description, although vibrations were specifically described as emanating from the sides of windows 26a, 26b, 26c, it should be clear that this is by way of example only. The vibration 26 may be sensed from other portions of the structure 14 instead of or in addition to the windows, for use in the threshold, comparison, or base line methods described herein.

Any trademarks listed herein are the property of their respective owners, and reference herein to such trademarks is intended only to indicate the source of a particular product or service.

The many features and advantages of the present invention are apparent from the detailed specification and it is intended by the appended claim to cover all such features and advantages of the described methods which follow in the true scope of the invention. Further, since numerous modifications and changes will readily occur to those of ordinary skill in the art, it is not desired to limit the invention to the exact implementation and operation illustrated and described. Accordingly, all suitable modifications and equivalents may be resorted to as falling within the scope of the invention.

1. A method comprising the steps of:
a) optically sensing vibration from a structure; and
b) determining whether a fault exists in the structure, based on the vibration optically-sensed in the step (a).

2. A method as claimed in claim 1 wherein the step (a) comprises substeps of:
al) generating and transmitting a laser beam to the structure;
a2) receiving the laser beam from the structure;
a3) detecting Doppler shift in the received laser beam relative to the transmitted laser beam; and
a4) determining at least one of the peak displacement and velocity of the vibration, based on the detecting of the substep (a3).

3. A method as claimed in claim 1 wherein the sensing of the step (a) is performed by sensing peak displacement of the vibration from at least one portion of the structure.

4. A method as claimed in claim 1 wherein the sensing of the step (a) is performed by sensing peak velocity of the vibration from at least one portion of the structure.

5. A method as claimed in claim 1 wherein the sensing of the step (a) comprises optically sensing vibrations from different portions of the structure corresponding to similar elements of the structure, the method further comprising:
c) comparing the vibrations from the different portions of the structure; and
the determining of step (b) performed based on the result of the comparing of the step (c).

6. A method as claimed in claim 5 wherein the comparing of the substep (b1) is performed based on peak displacement of the vibrations.

7. A method as claimed in claim 5 wherein the comparing of the substep (b1) is performed based on peak velocity of the vibrations.

8. A method as claimed in claim 1 wherein the step (a) is performed with a laser vibrometer.

9. A method as claimed in claim 1 wherein the step (a) is performed with a Doppler laser vibrometer.

10. A method as claimed in claim 1 wherein step (b) is performed with a computer.

11. A method as claimed in claim 1 further comprising the step of:
c) vibrating the structure to produce the vibration sensed in the step (a).

12. A method as claimed in claim 11 wherein the step (c) comprises vibrating the ground in proximity to the structure to cause the structure to vibrate.

13. A method as claimed in claim 11 wherein the step (c) comprises driving a vehicle over spaced objects to vibrate the structure.

14. A method as claimed in claim 11 wherein the step (c) comprises vibrating the ground with an ground vibrator.

15. A method as claimed in claim 11 wherein the step (c) comprises vibrating the ground by generating an explosion.

16. A method as claimed in claim 11 wherein the step (c) is performed by generating sonic waves.

17. A method as claimed in claim 16 wherein the sonic waves are generated with a speaker.

18. A method as claimed in claim 16 wherein the sonic waves are generated by noise from a helicopter.

19. A method as claimed in claim 11 wherein the structure is vibrated by direct application of force to the structure.

20. A method as claimed in claim 19 wherein the direct application of force is produced by bumping the structure with a vehicle.

21. A method as claimed in claim 11 wherein the step (c) is performed by exposing the structure to wind loading.

22. A method as claimed in claim 1 wherein the structure is a building.

23. A method as claimed in claim 1 wherein the structure is a house.

24. A method as claimed in claim 1 wherein the performance of the step (b) determines that the fault exists in the structure, the fault being damage of a structure element.

25. A method as claimed in claim 24 wherein the structure element comprises at least one of a foundation, roof, ceiling, floor, wall, beam, column, support, joist, wall, wall panel, wall frame, window, window frame, duct, plumbing, piping, or hanger.

26. A method as claimed in claim 1 wherein the performance of the step (b) determines that the fault exists in the structure, the fault being deterioration of a structure element.

27. A method as claimed in claim 26 wherein the structure element comprises at least one of a foundation, roof, ceiling, floor, wall, beam, column, support, joist, wall, wall panel, wall frame, window, window frame, duct, plumbing, piping, or hanger.

28. A method as claimed in claim 1 wherein the performance of the step (b) determines that the fault exists in the structure, the fault being a dislocation or separation between structure elements normally joined.

29. A method as claimed in claim 28 wherein the structure elements each comprise at least one of a foundation, roof, ceiling, floor, wall, beam, column, support, joist, wall, wall panel, wall frame, window, window frame, duct, plumbing, piping, or hanger.

30. A method as claimed in claim 1 wherein the performance of the step (c) determines that the fault exists in the structure, the fault being an improper joining of structure elements.

31. A method as claimed in claim 30 wherein the structure elements each comprise at least one of a foundation, roof, ceiling, floor, wall, beam, column, support, joist, wall, wall panel, wall frame, window, window frame, duct, plumbing, piping, or hanger.

32. A method comprising the steps of:
a) optically sensing vibrations at spaced portions of a structure to produce a first set of vibration data readings;
b) establishing base line data from the first set of vibration data readings for respective spaced portions of the structure;
c) at a time after completion of performance of the sensing of the step (a), optically sensing vibrations at the spaced portions of the structure to produce a second set of vibration data readings;
d) comparing the vibration data readings of the second set with corresponding vibration data readings of the first set constituting the base line data to generate comparison result data; and
e) determining whether a fault exists in the structure at the time of performance of step (c), based on the comparison result data of the step (d).

33. A method as claimed in claim 32 wherein the step (a) comprises substeps of:
a1) generating a laser beam and transmitting the laser beam to the structure;
a2) receiving the laser beam from the structure, the received laser beam shifted in phase relative to the transmitted laser beam due to vibration of the structure;
a3) detecting the phase shift in the received laser beam; and
a4) determining at least one of the peak displacement and velocity of the vibration, based on the detecting of the substep (a3).

34. A method as claimed in claim 32 wherein the step (c) comprises substeps of:
c1) generating a laser beam and transmitting the laser beam to the structure;
c2) receiving the laser beam from the structure, the received laser beam shifted in phase relative to the transmitted laser beam due to vibration of the structure;
c3) detecting the phase shift in the received laser beam; and
c4) determining at least one of the peak displacement and velocity of the vibration, based on the detecting of the substep (c3).

35. A method as claimed in claim 32 wherein the comparing of the step (d) comprises comparing vibration data sensed in the steps (a) and (c) from different portions of the structure corresponding to similar elements of the structure.

36. A method as claimed in claim 32 wherein the comparing of the substep (b) is performed based on peak displacement of the vibrations.

37. A method as claimed in claim 32 wherein the comparing of the substep (b) is performed based on peak velocity of the vibrations.

38. A method as claimed in claim 32 wherein the step (a) is performed with a laser vibrometer.

39. A method as claimed in claim 32 wherein the step (a) is performed with a Doppler laser vibrometer.

40. A method as claimed in claim 32 wherein step (b) is performed with a computer.

41. A method as claimed in claim 32 wherein step (d) is performed with a computer.

42. A method as claimed in claim 32 wherein step (e) is performed with a computer.

43. A method as claimed in claim 32 further comprising the step of:
f) vibrating the structure to produce the vibration sensed in at least one of the steps (a) and (c).

44. A method as claimed in claim 43 wherein the step (f) comprises vibrating ground in proximity to the structure to cause the structure to vibrate.

45. A method as claimed in claim 43 wherein the step (f) comprises driving a vehicle over spaced objects to vibrate the structure.

46. A method as claimed in claim 43 wherein the step (f) comprises vibrating the ground with a ground vibrator.

47. A method as claimed in claim 43 wherein the step (f) comprises vibrating the ground by generating an explosion.

48. A method as claimed in claim 43 wherein the step (f) is performed by generating sonic waves to cause the structure to vibrate.

49. A method as claimed in claim 48 wherein the sonic waves are generated with a speaker.

50. A method as claimed in claim 48 wherein the sonic waves are generated by noise from a helicopter.

51. A method as claimed in claim 43 wherein the structure is vibrated in the step (f) by direct application of force to the structure.

52. A method as claimed in claim 51 wherein the direct application of force is produced by bumping the structure with a vehicle.

53. A method as claimed in claim 43 wherein the step (f) is performed by exposing the structure to wind loading.

54. A method as claimed in claim 1 wherein the structure is a building.

55. A method as claimed in claim 1 wherein the structure is a house.

56. A method as claimed in claim 1 wherein the performance of the step (b) determines that the fault exists in the structure, the fault being damage of a structure element.

57. A method as claimed in claim 56 wherein the structure element comprises at least one of a foundation, roof, ceiling, floor, wall, beam, column, support, joist, wall, wall panel, wall frame, window, window frame, duct, plumbing, piping, or hanger.

58. A method as claimed in claim 1 wherein the performance of the step (b) determines that the fault exists in the structure, and the fault is deterioration of a structure element.

59. A method as claimed in claim 56 wherein the structure element comprises at least one of a foundation, roof, ceiling, floor, wall, beam, column, support, joist, wall, wall panel, wall frame, window, window frame, duct, plumbing, piping, or hanger.

60. A method as claimed in claim 1 wherein the performance of the step (c) determines that the fault exists in the structure, and the fault is a dislocation or separation between structure elements normally joined.

61. A method as claimed in claim 60 wherein the structure elements each comprise at least one of a foundation, roof, ceiling, floor, wall, beam, column, support, joist, wall, wall panel, wall frame, window, window frame, duct, plumbing, piping, or hanger.

62. A method as claimed in claim 1 wherein the performance of the step (c) determines that the fault exists in the structure, and the fault is an improper joining of structure elements.

63. A method as claimed in claim 62 wherein the structure elements each comprise at least one of a foundation, roof, ceiling, floor, wall, beam, column, support, joist, wall, wall panel, wall frame, window, window frame, duct, plumbing, piping, or hanger.

64. A system for detecting a fault in a structure, the system comprising:
an optical vibration sensor (OVS) positioned in proximity to the structure, the OVS optically sensing vibration of the structure, the OVS generating an OVS signal based on the sensed vibration from the structure, the OVS signal indicating whether the fault exists in the structure.

65. A system as claimed in claim 64 further comprising:
a computer coupled to receive the OVS signal, the computer generating a display based on the OVS signal, the display used by a human user to determine whether a fault exists in the structure.

66. A system as claimed in claim 64 further comprising:
a computer coupled to receive the OVS signal, the computer determining whether a fault exists in structure based on the OVS signal, the computer generating a computer signal indicating whether the fault exists in the structure.

67. A system as claimed in claim 64 wherein the computer generates the computer signal to indicate that a fault exists in the structure if the computer signal indicates that a peak displacement of the vibration at a portion of the structure, exceeds threshold amount data stored in the computer.

68. A system as claimed in claim 64 wherein the computer generates the computer signal to indicate that a fault exists in the structure if the computer determines that the OVS signal indicates that a peak velocity of the vibration at a portion of the structure, exceeds threshold amount data stored in the computer.

69. A system as claimed in claim 64 wherein the computer stores the OVS signal having vibration data for different portions of the structure, the computer determining whether a fault exists in the structure by comparing vibration data for similar structure elements to determine if there is a difference in the vibration data of similar structure elements, the computer determining that a fault exists in the structure if the difference between vibration data from similar structure elements exceeds threshold data stored in the computer.

70. A system as claimed in claim 64 wherein the OVS generates the OVS signal in a first performance of optical sensing to establish baseline data including vibration data readings at spaced portions over the structure, and generates the OVS signal at a second, subsequent performance of the optical sensing to generate after-acquired data including vibration data readings at spaced portions over the structure, the computer comparing the after-acquired data with corresponding baseline data, and determining a fault to exist in the structure if the difference between the after-acquired data and the baseline data exceeds threshold data stored in the computer.

71. A system as claimed in claim 64 further comprising:
an output device coupled to the computer, the output device generating a printed document, based on the computer signal.

72. A system as claimed in claim 64 wherein the computer comprises a drive unit for writing data indicating whether a fault exists in the structure onto a computer readable-medium, based on the computer signal.

73. A system as claimed in claim 64 wherein the computer is coupled to supply the computer signal indicating whether a fault exists in the structure to a remote computer via a network.

74. A system as claimed in claim 64 further comprising:
an OVS controller (OVSC) coupled to receive the signal from the OVS, the OVSC generating a vibration signal indicating vibration displacement of at least one portion of the structure, the OVSC coupled to supply the vibration signal indicating the vibration displacement to the computer as the OVS signal.

75. A system as claimed in claim 65 further comprising:
an OVS controller (OVSC) coupled to receive the signal from the OVS, the OVSC generating a signal indicating vibration velocity of at least one portion of the structure, the OVSC coupled to supply the signal indicating the vibration velocity to the computer as the OVS signal.

76. A system as claimed in claim 65 wherein the OVSC is coupled to the OVS, and is operable to automatically focus the OVS on the structure.

77. A system as claimed in claim 65 further comprising:
a tripod coupled to the OVS, the tripod for positioning and supporting the OVS in relation to the structure.

78. A system as claimed in claim 65 further comprising:
a pan/tilt head coupled to the OVS, for aligning the OVS relative to the structure.

79. A system as claimed in claim 78 further comprising:
a position controller coupled to the pan/tilt head, the position controller controllable to generate a position signal supplied to the pan/tilt head to control alignment of the OVS relative to the structure.

80. A system as claimed in claim 79 further comprising:
a computer coupled to the position controller, the computer generating a position control signal supplied to the position controller, the position controller generating the position signal based on the position control signal.

81. A system as claimed in claim 64 wherein the OVS comprises a laser/sensor head.

82. A system as claimed in claim 81 wherein the OVS comprises an optical element coupled to the laser/sensor head.

83. A system as claimed in claim 82 wherein the optical element is a filter.

84. A system as claimed in claim 82 wherein the optical element is a lens.

85. A system as claimed in claim 81 wherein the OVS further comprises a scan unit for scanning a laser beam generated by the laser/sensor head over different portions of the structure, and for receiving the scanned laser beam from the different portions of the structure.

86. A system as claimed in claim 64 further comprising:
a vibration generator positioned in proximity to the structure, the vibration generator producing vibrations that travel to and vibrate the structure.

87. A system as claimed in claim 86 wherein the vibration generator comprises a vehicle and spaced objects, the vehicle driving over the spaced objects to vibrate the ground in proximity to the structure, to in turn vibrate the structure.

88. A system as claimed in claim 86 wherein the vibration generator comprises a ground vibrator that vibrates the ground in proximity to the structure, to in turn vibrate the structure.

89. A system as claimed in claim 86 wherein the vibration generator comprises a speaker generating sonic waves in proximity to the structure.

90. A system as claimed in claim 86 wherein the vibration generator comprises an explosive detonated in proximity to the structure to produce a shock wave to vibrate the structure.

91. A system as claimed in claim 86 wherein the vibration generator comprises a helicopter generating noise, the helicopter flown in proximity to the structure to vibrate the structure with the noise generated by the helicopter.

92. A system as claimed in claim 86 wherein the vibration generator applies direct force to the structure.

93. A system as claimed in claim 92 wherein the vibration generator is a vehicle driven to bump and vibrate the structure.
